(19) United States
(12) Patent Application Publication
(10) Pub. No.: US 2023/0035199 A1
(43) Pub. Date: Feb. 2, 2023

(54) Roasting Basket

(71) Applicant: Joseph Hines, Grove City, PA (US)

(72) Inventor: Joseph Hines, Grove City, PA (US)

(21) Appl. No.: 17/716,454

(22) Filed: Apr. 8, 2022

Related U.S. Application Data
(60) Provisional application No. 63/174,621, filed on Apr. 14, 2021.

(51) Int. Cl. A47J 37/04; A47J 33/00; A47J 43/28

(52) U.S. Cl. CPC A47J 37/04; A47J 33/00; A47J 43/283

(57) ABSTRACT

Provided herein are embodiments of a roasting basket, for example, a collapsible roasting basket for cooking items, for example, food items. The collapsible roasting basket described herein comprises a wire body having a top portion, a bottom portion, an expanded configuration, a collapsed configuration, and a handle receiver located in the top portion.

### CROSS-REFERENCE TO RELATED APPLICATION

The present application claims priority to U.S. Provisional Application No. 63/174,621, entitled “Roasting Basket”, filed Apr. 14, 2021, the entire disclosure of which is hereby incorporated by reference in its' entirety.

### SUMMARY OF THE INVENTION

### Field of the Invention

The present invention is directed towards a roasting basket, for example, a collapsible roasting basket for cooking items, for example, food items, such as a hot dog.

During camping trips, picnics, or other outings, food items, such as hot dogs or sausages, can be cooked over an open fire. Typically, a sharpened stick or fork is used to hold the hot dog over the fire. Such devices are awkward to handle and inherently dangerous in that a sharp object is being handled. It is difficult to evenly cook a hot dog or sausage over an open flame as the stick or fork must be fully manipulated to get even heating of the food. Some of the disadvantages arising from the use of a stick or a fork are that the food sometimes falls from the stick during the cooking, or brushes against the logs or the ground thus contaminating the food. In piercing the skin of a hot dog, there is a loss of juices that degrade the taste of the cooked product. With a single stick or a fork, it is hard to cook two or more hot dogs at the same time. Additional disadvantages include the difficultly of transporting and/or re-using traditional objects used to cook the hog dog over the fire.

U.S. Pat. No. 6,701,827 discloses a device that provides rotary placement of a food being roasted over an open heat source such as a campfire. Food such as hot dogs, wieners, sausages, and ears of corn may be placed into the cooking apparatus and roasted over an open fire. The device is adaptable for holding other food items, such as marshmallows, by the use of an accessory holder.

U.S. Patent Application Publication No. 2006/0076789 discloses a cookout food cooker having a powered rotisserie device for turning a food item at a predetermined speed over an open fire, at least one extendable attachment for supporting a food to be cooked, and a coupler for putting cooking attachments onto the rotisserie device.

U.S. Pat. No. 6,754,966 discloses a wiener roaster with prongs that may be folded back. The prongs are pivotably received by a head, and the head is attached at the end of a roaster stalk. The prong has a continuous curve as it enters the head which produces friction to hold the prongs at an adjustable angle away from or towards the roaster stalk. The bore in the head may have beveled, oval-shaped openings, so that the curved base of the prong notches into place in extended and folded back positions. The roaster may also have a tension shoe for applying and distributing pressure on the prongs and a notch in the prongs for receiving the tension shoe. A hole in the top of the head allows lubricant, such as oil or fat from cooking food, to enter the head and lubricate the base of the prong and the tension shoe. The lubrication hole may also be threaded to receive a set screw, which can provide additional pressure to hold the prong in place. In another alternative embodiment, the base of the prong has notches to receive the tip of the roaster stalk. In this embodiment, the prong is held in its extended and folded back positions when the tip of the stalk enters the notches in the base of the prong. The end of the stalk may be threaded to receive the head, so that the head can be screwed out a little to allow the base of the prong to clear the tip of the stalk, thereby permitting the prong to be swiveled to its extended or folded position. Alternatively, a spring and ball at the end of the stalk can exert enough pressure to hold the ball in the notches of the prong base to hold the prong in position, yet still allow the prong to be swiveled.

Accordingly, there is a need for a collapsible roasting basket to evenly cook one or more food items, for example, one or more hot dogs, over an open flame that prevents the food item(s) from falling during the cooking, prevents contamination of the food item, prevents the loss of juices that degrade the taste of the food item, and/or allows for transporting and/or re-using the collapsible roasting basket.

In one aspect or embodiment of the subject matter disclosed herein, a collapsible roasting basket is provided. The collapsible roasting basket comprises a wire body having a top portion, a bottom portion, an expanded configuration, and a collapsed configuration. The collapsible roasting basket further comprises a handle receiver located in the top portion. In some embodiments, the handle receiver has a first end and a second end. In some embodiments, the first end of the handle receiver engages a portion of the top portion of the wire body.

Various aspects of the present disclosure may be further characterized by one or more of the following clauses:

Clause 1: A collapsible roasting basket, comprising a wire body having a top portion, a bottom portion, an expanded configuration, and a collapsed configuration; and a handle receiver located in the top portion, the handle receiver having a first end and a second end, the first end engaging a portion of the top portion of the wire body.

Clause 2: The collapsible roasting basket of clause 1, wherein the second end of the handle receiver comprises an integral hook.

Clause 3: The collapsible roasting basket of clause 1 or 2, further comprising a hook receiver located in the bottom portion of the wire body.

Clause 4: The collapsible roasting basket of any one of clauses 1 to 3, wherein in the collapsed configuration, the integral hook of the handle receiver engages the hook receiver.

Clause 5: The collapsible roasting basket of any one of clauses 1 to 4, wherein the wire body, the handle receiver, and the hook receiver comprise one or more material.

Clause 6: The collapsible roasting basket of any one of clauses 1 to 5, wherein the one or more material is a heat resistant material or a resilient material.

Clause 7: The collapsible roasting basket of any one of clauses 1 to 5, wherein the one or more material is a heat resistant material.

Clause 8: The collapsible roasting basket of any one of clauses 1 to 5, wherein the one or more material is a resilient material.

Clause 9: The collapsible roasting basket of any one of clauses 1 to 5, wherein the one or more material is a heat resistant material and a resilient material.

Clause 10: The collapsible roasting basket of any one of clauses 1 to 9, wherein the one or more material is one or more of stainless steel, spring steel, steel, steel alloy, carbon steel, cobalt-nickel, copper, copper alloy, copper wire, nickel, nickel alloy, titanium, low-alloy manganese, medium-carbon steel, or high-carbon steel.

Clause 11: The collapsible roasting basket of any one of clauses 1 to 9, wherein the one or more material is stainless steel.

Clause 12: The collapsible roasting basket of any one of clauses 1 to 9, wherein the one or more material is spring steel.

Clause 13: The collapsible roasting basket of any one of clauses 1 to 9, wherein the one or more material is steel.

Clause 14: The collapsible roasting basket of any one of clauses 1 to 9, wherein the one or more material is steel alloy.

Clause 15: The collapsible roasting basket of any one of clauses 1 to 9, wherein the one or more material is carbon steel.

Clause 16: The collapsible roasting basket of any one of clauses 1 to 9, wherein the one or more material is cobalt-nickel.

Clause 17: The collapsible roasting basket of any one of clauses 1 to 9, wherein the one or more material is copper.

Clause 18: The collapsible roasting basket of any one of clauses 1 to 9, wherein the one or more material is copper alloy.

Clause 19: The collapsible roasting basket of any one of clauses 1 to 9, wherein the one or more material is copper wire.

Clause 20: The collapsible roasting basket of any one of clauses 1 to 9, wherein the one or more material is nickel.

Clause 21: The collapsible roasting basket of any one of clauses 1 to 9, wherein the one or more material is nickel alloy.

Clause 22: The collapsible roasting basket of any one of clauses 1 to 9, wherein the one or more material is titanium.

Clause 23: The collapsible roasting basket of any one of clauses 1 to 9, wherein the one or more material is low-alloy manganese.

Clause 24: The collapsible roasting basket of any one of clauses 1 to 9, wherein the one or more material is medium-carbon steel.

Clause 25: The collapsible roasting basket of any one of clauses 1 to 9, wherein the one or more material is high-carbon steel.

Clause 26: The collapsible roasting basket of any one of clauses 1 to 25, wherein the one or more material is one continuous piece of material.

Clause 27: The collapsible roasting basket of any one of clauses 1 to 26, wherein the one or more material has a coating.

Clause 28: The collapsible roasting basket of any one of clauses 1 to 27, wherein the coating is a non-stick coating.

Clause 29: The collapsible roasting basket of any one of clauses 1 to 28, wherein the handle receiver is coiled.

Clause 30: The collapsible roasting basket of any one of clauses 1 to 29, wherein the handle receiver is a wire handle receiver.

Clause 31: The collapsible roasting basket of any one of clauses 1 to 30, further comprising a rod configured to engage the handle receiver.

Clause 32: The collapsible roasting basket of any one of clauses 1 to 31, wherein the rod is a telescoping rod.

Clause 33: The collapsible roasting basket of any one of clauses 1 to 32, wherein at least a portion of the handle receiver is located within the wire body of the collapsible roasting basket.

Clause 34: The collapsible roasting basket of any one of clauses 1 to 33, wherein at least a portion of the handle receiver is located outside the wire body of the collapsible roasting basket.

Clause 35: The collapsible roasting basket of any one of clauses 1 to 34, wherein the wire body is coiled.

Clause 36: The collapsible roasting basket of any one of clauses 1 to 35, wherein the wire body is substantially circular, substantially square, or substantially tapered.

Clause 37: The collapsible roasting basket of any one of clauses 1 to 35, wherein the wire body is substantially circular.

Clause 38: The collapsible roasting basket of any one of clauses 1 to 35, wherein the wire body is substantially square.

Clause 39: The collapsible roasting basket of any one of clauses 1 to 35, wherein the wire body is substantially tapered.

Clause 40: The collapsible roasting basket of any one of clauses 1 to 39, wherein the handle receiver is substantially circular, substantially square, or substantially tapered.

Clause 41: The collapsible roasting basket of any one of clauses 1 to 39, wherein the handle receiver is substantially circular.

Clause 42: The collapsible roasting basket of any one of clauses 1 to 39, wherein the handle receiver is substantially square.

Clause 43: The collapsible roasting basket of any one of clauses 1 to 39, wherein the handle receiver is substantially tapered.

Clause 44: The collapsible roasting basket of any one of clauses 1 to 43, wherein the bottom portion of the wire body comprises a bottom plate.

Clause 45: The collapsible roasting basket of any one of clauses 1 to 44, wherein the wire body in the expanded configuration has a length in a range from about 5 inches to about 9 inches.

Clause 46: The collapsible roasting basket of any one of clauses 1 to 44, wherein the wire body in the expanded configuration has a length of about 5 inches.

Clause 47: The collapsible roasting basket of any one of clauses 1 to 44, wherein the wire body in the expanded configuration has a length of about 6 inches.

Clause 48: The collapsible roasting basket of any one of clauses 1 to 44, wherein the wire body in the expanded configuration has a length of about 7 inches.

Clause 49: The collapsible roasting basket of any one of clauses 1 to 44, wherein the wire body in the expanded configuration has a length of about 8 inches.

Clause 50: The collapsible roasting basket of any one of clauses 1 to 44, wherein the wire body in the expanded configuration has a length of about 9 inches.

Clause 51: The collapsible roasting basket of any one of clauses 1 to 50, wherein the wire body in the expanded configuration has a pitch in a range from about 0.4 inches to about 0.8 inches.

Clause 52: The collapsible roasting basket of any one of clauses 1 to 50, wherein the wire body in the expanded configuration has a pitch of about 0.4 inches.

Clause 53: The collapsible roasting basket of any one of clauses 1 to 50, wherein the wire body in the expanded configuration has a pitch of about 0.5 inches.

Clause 54: The collapsible roasting basket of any one of clauses 1 to 50, wherein the wire body in the expanded configuration has a pitch of about 0.6 inches.

Clause 55: The collapsible roasting basket of any one of clauses 1 to 50, wherein the wire body in the expanded configuration has a pitch of about 0.7 inches.

Clause 56: The collapsible roasting basket of any one of clauses 1 to 50, wherein the wire body in the expanded configuration has a pitch of about 0.8 inches.

Clause 57: The collapsible roasting basket of any one of clauses 1 to 56, wherein the wire body has a diameter in a range from about 2.0 inches to about 5.0 inches.

Clause 58: The collapsible roasting basket of any one of clauses 1 to 56, wherein the wire body has a diameter of about 2.0 inches.

Clause 59: The collapsible roasting basket of any one of clauses 1 to 56, wherein the wire body has a diameter of about 2.5 inches.

Clause 60: The collapsible roasting basket of any one of clauses 1 to 56, wherein the wire body has a diameter of about 3.0 inches.

Clause 61: The collapsible roasting basket of any one of clauses 1 to 56, wherein the wire body has a diameter of about 3.5 inches.

Clause 62: The collapsible roasting basket of any one of clauses 1 to 56, wherein the wire body has a diameter of about 4.0 inches.

Clause 63: The collapsible roasting basket of any one of clauses 1 to 56, wherein the wire body has a diameter of about 4.5 inches.

Clause 64: The collapsible roasting basket of any one of clauses 1 to 56, wherein the wire body has a diameter of about 5.0 inches.

Clause 65: The collapsible roasting basket of any one of clauses 1 to 64, wherein the wire body in the collapsed configuration has a length in a range from about 0.1 inches to about 4.0 inches.

Clause 66: The collapsible roasting basket of any one of clauses 1 to 64, wherein the wire body in the collapsed configuration has a length of about 0.1 inches.

Clause 67: The collapsible roasting basket of any one of clauses 1 to 64, wherein the wire body in the collapsed configuration has a length of about 0.5 inches.

Clause 68: The collapsible roasting basket of any one of clauses 1 to 64, wherein the wire body in the collapsed configuration has a length of about 1.0 inch.

Clause 69: The collapsible roasting basket of any one of clauses 1 to 64, wherein the wire body in the collapsed configuration has a length of about 2.0 inches.

Clause 70: The collapsible roasting basket of any one of clauses 1 to 64, wherein the wire body in the collapsed configuration has a length of about 3.0 inches.

Clause 71: The collapsible roasting basket of any one of clauses 1 to 64, wherein the wire body in the collapsed configuration has a length of about 4.0 inches.

Clause 72: The collapsible roasting basket of any one of clauses 1 to 71, wherein the wire body has a taper up to 5.0 degrees.

Clause 73: The collapsible roasting basket of any one of clauses 1 to 71, wherein the wire body does not have a taper.

Clause 74: The collapsible roasting basket of any one of clauses 1 to 71, wherein the wire body has a taper of 0.5 degrees.

Clause 75: The collapsible roasting basket of any one of clauses 1 to 71, wherein the wire body has a taper of 1.0 degree.

Clause 76: The collapsible roasting basket of any one of clauses 1 to 71, wherein the wire body has a taper of 1.5 degrees.

Clause 77: The collapsible roasting basket of any one of clauses 1 to 71, wherein the wire body has a taper of 2.0 degrees.

Clause 78: The collapsible roasting basket of any one of clauses 1 to 71, wherein the wire body has a taper of 2.5 degrees.

Clause 79: The collapsible roasting basket of any one of clauses 1 to 71, wherein the wire body has a taper of 3.0 degrees.

Clause 80: The collapsible roasting basket of any one of clauses 1 to 71, wherein the wire body has a taper of 3.5 degrees.

Clause 81: The collapsible roasting basket of any one of clauses 1 to 71, wherein the wire body has a taper of 4.0 degrees.

Clause 82: The collapsible roasting basket of any one of clauses 1 to 71, wherein the wire body has a taper of 4.5 degrees.

Clause 83: The collapsible roasting basket of any one of clauses 1 to 71, wherein the wire body has a taper of 5.0 degrees.

Clause 84: The collapsible roasting basket of any one of clauses 1 to 83, wherein the handle receiver has a length in a range from about 0.5 inches to about 3.0 inches.

Clause 85: The collapsible roasting basket of any one of clauses 1 to 83, wherein the handle receiver has a length of about 0.5 inches.

Clause 86: The collapsible roasting basket of any one of clauses 1 to 83, wherein the handle receiver has a length of about 1.0 inch.

Clause 87: The collapsible roasting basket of any one of clauses 1 to 83, wherein the handle receiver has a length of about 1.5 inches.

Clause 88: The collapsible roasting basket of any one of clauses 1 to 83, wherein the handle receiver has a length of about 1.75 inches.

Clause 89: The collapsible roasting basket of any one of clauses 1 to 83, wherein the handle receiver has a length of about 2.0 inches.

Clause 90: The collapsible roasting basket of any one of clauses 1 to 83, wherein the handle receiver has a length of about 2.5 inches.

Clause 91: The collapsible roasting basket of any one of clauses 1 to 83, wherein the handle receiver has a length of about 3.0 inches.

Clause 92: The collapsible roasting basket of any one of clauses 1 to 91, wherein the handle receiver has a pitch in a range from about 0.05 inches to about 0.4 inches.

Clause 93: The collapsible roasting basket of any one of clauses 1 to 91, wherein the handle receiver has a pitch of about 0.05 inches.

Clause 94: The collapsible roasting basket of any one of clauses 1 to 91, wherein the handle receiver has a pitch of about 0.1 inches.

Clause 95: The collapsible roasting basket of any one of clauses 1 to 91, wherein the handle receiver has a pitch of about 0.15 inches.

Clause 96: The collapsible roasting basket of any one of clauses 1 to 91, wherein the handle receiver has a pitch of about 0.2 inches.

Clause 97: The collapsible roasting basket of any one of clauses 1 to 91, wherein the handle receiver has a pitch of about 0.25 inches.

Clause 98: The collapsible roasting basket of any one of clauses 1 to 91, wherein the handle receiver has a pitch of about 0.3 inches.

Clause 99: The collapsible roasting basket of any one of clauses 1 to 91, wherein the handle receiver has a pitch of about 0.35 inches.

Clause 100: The collapsible roasting basket of any one of clauses 1 to 91, wherein the handle receiver has a pitch of about 0.4 inches.

Clause 101: The collapsible roasting basket of any one of clauses 1 to 100, wherein the handle receiver has a taper up to 5.0 degrees.

Clause 102: The collapsible roasting basket of any one of clauses 1 to 100, wherein the handle receiver does not have a taper.

Clause 103: The collapsible roasting basket of any one of clauses 1 to 100, wherein the handle receiver has a taper of about 0.5 degrees.

Clause 104: The collapsible roasting basket of any one of clauses 1 to 100, wherein the handle receiver has a taper of about 1.0 degree.

Clause 105: The collapsible roasting basket of any one of clauses 1 to 100, wherein the handle receiver has a taper of about 1.5 degrees.

Clause 106: The collapsible roasting basket of any one of clauses 1 to 100, wherein the handle receiver has a taper of about 2.0 degrees.

Clause 107: The collapsible roasting basket of any one of clauses 1 to 100, wherein the handle receiver has a taper of about 2.5 degrees.

Clause 108: The collapsible roasting basket of any one of clauses 1 to 100, wherein the handle receiver has a taper of about 3.0 degrees.

Clause 109: The collapsible roasting basket of any one of clauses 1 to 100, wherein the handle receiver has a taper of about 3.5 degrees.

Clause 110: The collapsible roasting basket of any one of clauses 1 to 100, wherein the handle receiver has a taper of about 4.0 degrees.

Clause 111: The collapsible roasting basket of any one of clauses 1 to 100, wherein the handle receiver has a taper of about 4.5 degrees.

Clause 112: The collapsible roasting basket of any one of clauses 1 to 100, wherein the handle receiver has a taper of about 5.0 degrees.

Clause 113: The collapsible roasting basket of any one of clauses 1 to 112, wherein the handle receiver has a diameter in a range from about 0.5 inches to about 1.5 inches.

Clause 114: The collapsible roasting basket of any one of clauses 1 to 112, wherein the handle receiver has a diameter of about 0.5 inches.

Clause 115: The collapsible roasting basket of any one of clauses 1 to 112, wherein the handle receiver has a diameter of about 1.0 inch.

Clause 116: The collapsible roasting basket of any one of clauses 1 to 112, wherein the handle receiver has a diameter of about 1.5 inches.

Clause 117: The collapsible roasting basket of any one of clauses 1 to 116, wherein the wire body comprises an outer surface and an inner surface.

Clause 118: The collapsible roasting basket of any one of clauses 1 to 117, wherein the outer surface has an identification plate.

Clause 119: The collapsible roasting basket of any one of clauses 1 to 118, wherein a length from a center of the handle receiver to the outer surface of the wire body is in a range from about 0.5 inches to about 1.5 inches.

Clause 120: The collapsible roasting basket of any one of clauses 1 to 118, wherein a length from a center of the handle receiver to the outer surface of the wire body is about 0.5 inches.

Clause 121: The collapsible roasting basket of any one of clauses 1 to 118, wherein a length from a center of the handle receiver to the outer surface of the wire body is about 1.0 inch.

Clause 122: The collapsible roasting basket of any one of clauses 1 to 118, wherein a length from a center of the handle receiver to the outer surface of the wire body is about 1.5 inches.

### BRIEF DESCRIPTION OF THE DRAWINGS

FIG. 1A is a perspective view of an embodiment of a collapsible roasting basket in an expanded configuration.

FIG. 1B is a perspective view of an embodiment of a collapsible roasting basket in an expanded configuration.

FIG. 1C is a perspective view of a further embodiment of a collapsible roasting basket in an expanded configuration.

FIG. 1D is a perspective view of an embodiment of a collapsible roasting basket in a collapsed configuration.

FIG. 1E is a top view of an embodiment of a collapsible roasting basket.

FIG. 1F is a side view of an embodiment of a collapsible roasting basket in an expanded configuration.

FIG. 2A is a perspective view of an embodiment of a collapsible roasting basket in an expanded configuration.

FIG. 2B is a perspective view of an embodiment of a collapsible roasting basket in an expanded configuration.

FIG. 2C is a perspective view of an embodiment of a collapsible roasting basket in a collapsed configuration.

FIG. 2D is a side view of an embodiment of a collapsible roasting basket in a collapsed configuration.

FIG. 2E is a side view of an embodiment of a collapsible roasting basket in an expanded configuration.

FIG. 2F is a top view of an embodiment of a collapsible roasting basket.

FIG. 3A is a perspective view of an embodiment of a collapsible roasting basket in an expanded configuration.

FIG. 3B is a top view of an embodiment of a collapsible roasting basket.

FIG. 3C is a side view of an embodiment of a collapsible roasting basket in an expanded configuration.

### DESCRIPTION OF THE INVENTION

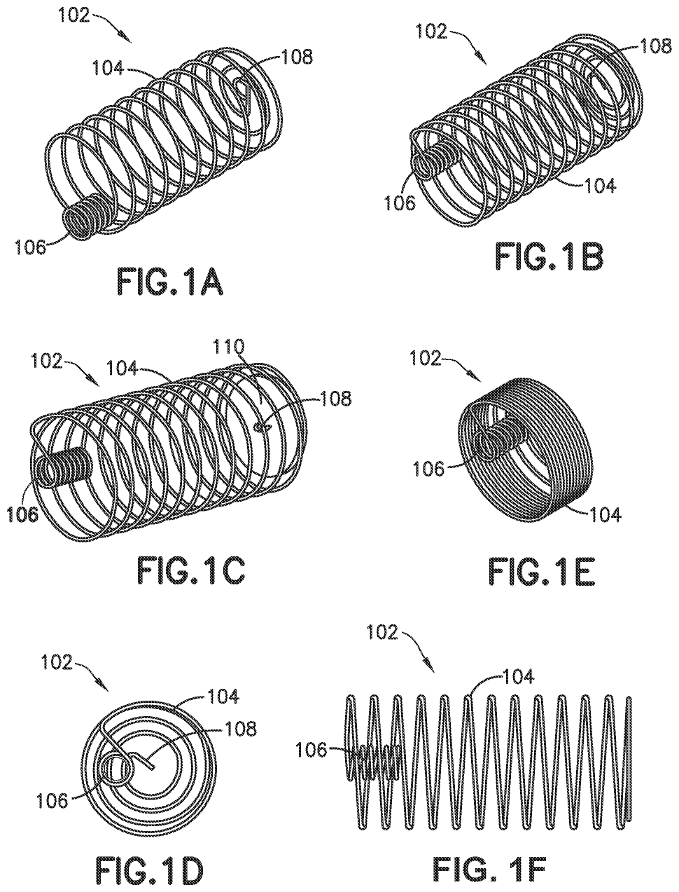

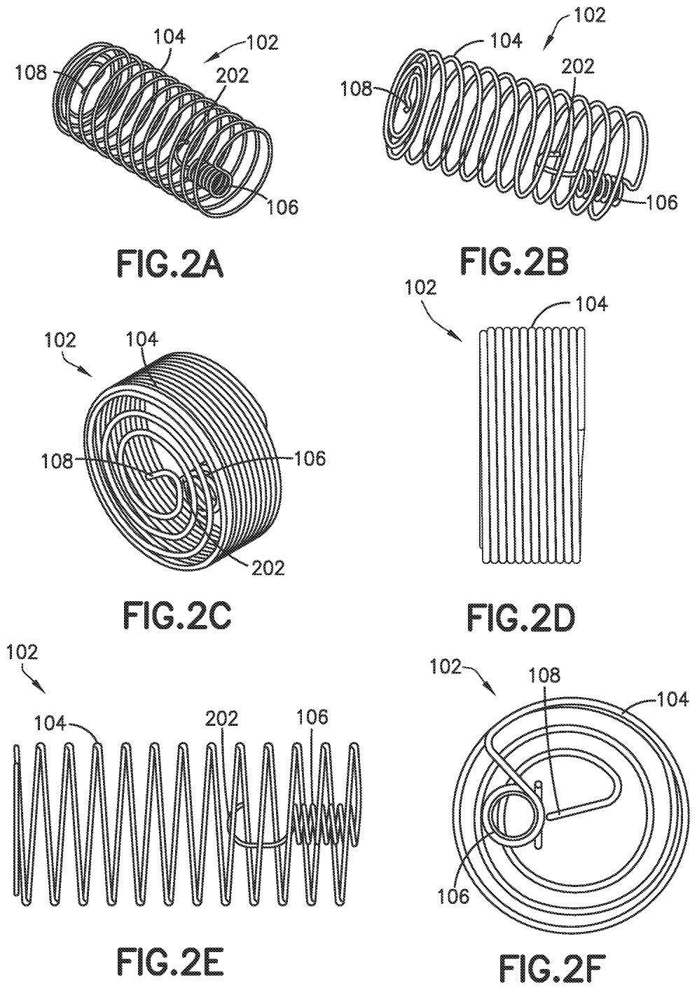

Embodiments will now be described with reference to FIGS. 1A-1F, 2A-F, and 3A-3C, which relate to a collapsible roasting basket in an expanded or collapsed configuration. Moreover, it is contemplated that while the present invention is disclosed hereinafter with respect to a collapsible roasting basket to cook one or more food items, in particular hot dogs or sausages, the present invention may be used in a variety of other cooking apparatuses, for example, roasters or rotisseries for cooking a variety of food items.

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of elements used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

FIGS. 1A-1F are embodiments of a collapsible roasting basket 102 in an expanded and a collapsed configuration. Collapsible roasting basket 102 comprises wire body 104 having a top portion, a bottom portion, an expanded configuration (FIGS. 1A-1C and 1F), and a collapsed configuration (FIG. 1D). In some embodiments, a handle receiver (or handle retainer) 106 is located in the top portion of wire body 104. Handle receiver 106 may comprise a first end and a second end, wherein the first end engages a portion of the top portion of wire body 104. In some embodiments, collapsible roasting basket 102 may comprise hook receiver 108 which is located in the bottom portion of wire body 104. In some embodiments, the bottom portion of wire body 104 may comprise a bottom plate 110 as illustrated in FIG. 1C.

FIGS. 2A-2F are embodiments of a collapsible roasting basket 102 in an expanded and collapsed configuration having an integral hook 202. As depicted in FIGS. 2A-2F, collapsible roasting basket 102 comprises wire body 104 having a top portion, a bottom portion, an expanded configuration (FIGS. 2A-2B and 2E), and a collapsed configuration (FIGS. 2C-2D). Handle receiver 106 is located in the top portion of wire body 104. Handle receiver 106 may comprise a first end and a second end, wherein the first end engages a portion of the top portion of wire body 104. As illustrated in FIGS. 2A-2B and 2E, the second end of the handle receiver comprises integral hook 202 and is configured to engage hook receiver 108 located in the bottom portion of wire body 104 when collapsible roasting basket 102 is in the collapsed configuration (FIG. 2C).

As contemplated herein, wire body 104, the handle receiver 106, hook receiver 108, and/or integral hook 202 may comprise one or more material. In some embodiments, the one or more material is a heat resistant material or a resilient material. In some embodiments, the one or more material is a heat resistant material and a resilient material. A heat resistant material is any material that can protect various elements from heat generated due to high temperature. A resilient material, or heat resilient material, is any material that compresses and decompresses back to its original shape.

As contemplated herein, wire body 104, handle receiver 106, hook receiver 108, and/or integral hook 202 may comprise one or more material including, for example, stainless steel, spring steel, steel, steel alloy, carbon steel, cobalt-nickel, copper, copper alloy, copper wire, nickel, nickel alloy, titanium, low-alloy manganese, medium-carbon steel, and/or high-carbon steel. In some embodiments, wire body 104, handle receiver 106, hook receiver 108, and/or integral hook 202 may comprise one or more material that is preferably stainless steel. In further non-limiting embodiments, wire body 104, handle receiver 106, hook receiver 108, and/or integral hook 202 may comprise the one or more material is one continuous piece of material, for example, one continuous piece of stainless steel. As used herein, one continuous piece of material may also include one continuous stand of material as contemplated herein.

In some embodiments, wire body 104, handle receiver 106, hook receiver 108, and/or integral hook 202 having one or material, as described above, may further comprise a coating. As understood by those skilled in the art, coatings protect metal components and objects from damage like corrosion, for example, caustic agent corrosion from chemical exposure, galvanic corrosion from electrical contact, general corrosion, localized corrosion, or stress cracking. Coatings contemplated herein include coatings derived from, for example, electroplating, electroless plating or conversion, hot dipping, brush or roll coat, liquid and powder spraying. In some embodiments, the coating is a non-stick coating used in cookware and bakeware, for example, fluoropolymers, polytetrafluoroethylene (PTFE), fluoroplastic, anodized aluminium, or silica.

In some embodiments, wire body 104 and/or handle receiver 106 are coiled, for example, arranged in a joined sequence, or a regularly spaced sequence, of concentric circles or rings. In some embodiments, wire body 104 is coiled wire body. In some embodiments, handle receiver 106 is a wire handle receiver or a coiled wire handle receiver.

In some embodiments contemplated herein, collapsible roasting basket 102 may further comprise a rod configured to engage the handle receiver. In some embodiments, the rod is a telescoping rod. As is understood by those skilled in the art, a telescoping rod may be a rod made of concentric tubular parts configured to slide or cause to slide into itself, so that the telescoping rod becomes smaller.

As contemplated herein, handle receiver 106 can be located in various positions relative to wire body 104. As illustrated in FIGS. 1A-1D, at least a portion of handle receiver 106 is located outside an internal diameter of wire body 104 in the expanded and/or collapsed configurations. In further embodiments, handle receiver 106 can be located outside an internal diameter of wire body 106 such that no portion of handle receiver 106 is within the internal diameter of wire body 106 in the collapsed or expanded configuration. As illustrated in FIGS. 2A-2E, at least a portion of handle receiver 106 is located within an internal diameter of wire body 104 in the expanded and/or collapsed configuration. In some embodiments, handle receiver 106 can be located within an internal diameter of wire body 104 such that no portion of handle receiver 106 is outside the internal diameter of wire body 104 in the collapsed or expanded configuration.

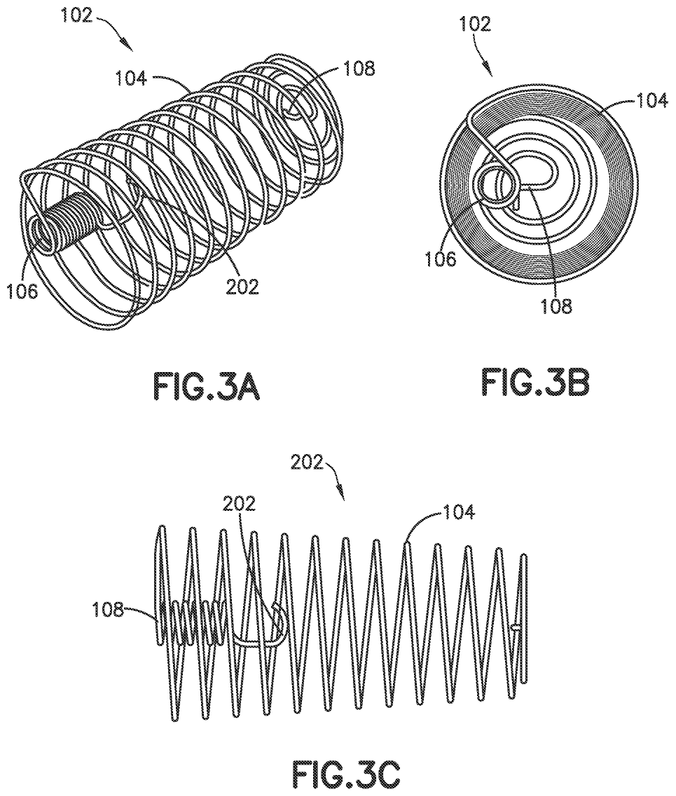

FIGS. 3A-3C illustrate embodiments of a collapsible roasting basket 102 in an expanded and collapsed configuration having integral hook 202, wherein wire body 104 has a taper. As depicted in FIGS. 3A-3C, collapsible roasting basket 102 comprises wire body 104 having a top portion, a bottom portion, an expanded configuration (FIGS. 3A and 3C), and a collapsed configuration (FIG. 3B). Handle receiver 106 is located in the top portion of wire body 104. As illustrated in FIGS. 3A-3C, handle receiver 106 is located within an internal diameter of wire body 106 such that no portion of handle receiver 106 is outside the internal diameter of wire body 106 in the collapsed or expanded configuration. Handle receiver 106 may comprise a first end and a second end, wherein the first end engages a portion of the top portion of wire body 104. As illustrated in FIGS. 3A and 3C, the second end of the handle receiver comprises integral hook 202 and is configured to engage hook receiver 108 located in the bottom portion of wire body 104 when collapsible roasting basket 102 is in the collapsed configuration (FIG. 3B). In some embodiments, hook receiver 108 is shaped as a hook. In further embodiments, hook receiver 108 and/or integral hook 202 may or may not be of the same shape, for example, a hook.

In some embodiments, wire body 104 has a taper up to 5.0 degrees. In some embodiments, the wire body does not have a taper. In some embodiments, the wire body has a taper of about 2.5 degrees. In some embodiments, the wire body has a taper in a range from about 0.5 degrees to about 5.0 degrees, from about 0.5 degrees, to about 4.5 degrees, from about 0.5 degrees, to about 4.0 degrees, from about 0.5 degrees, to about 3.5 degrees, from about 0.5 degrees, to about 3.0 degrees, from about 0.5 degrees, to about 2.5 degrees, from about 0.5 degrees, to about 2.0 degrees, from about 0.5 degrees, to about 1.5 degrees, from about 0.5 degrees, to about 1.0 degree, or any individual value therein. In some embodiments, the wire body has a taper in a range from about 1.0 degree to about 5.0 degrees, from about 1.5 degrees to about 5.0 degrees, from about 2.0 degrees to about 5.0 degrees, from about 2.5 degrees to about 5.0 degrees, from about 3.0 degrees to about 5.0 degrees, from about 3.5 degrees to about 5.0 degrees, from about 4.0 degrees to about 5.0 degrees, from about 4.5 degrees to about 5.0 degrees, or any individual value therein.

In some embodiments, handle receiver 106 has a taper up to 5.0 degrees. In some embodiments, the handle receiver does not have a taper. In some embodiments, the handle receiver has a taper of about 2.5 degrees. In some embodiments, the handle receiver has a taper in a range from about 0.5 degrees to about 5.0 degrees, from about 0.5 degrees, to about 4.5 degrees, from about 0.5 degrees, to about 4.0 degrees, from about 0.5 degrees, to about 3.5 degrees, from about 0.5 degrees, to about 3.0 degrees, from about 0.5 degrees, to about 2.5 degrees, from about 0.5 degrees, to about 2.0 degrees, from about 0.5 degrees, to about 1.5 degrees, from about 0.5 degrees, to about 1.0 degree, or any individual value therein. In some embodiments, the handle receiver has a taper in a range from about 1.0 degree to about 5.0 degrees, from about 1.5 degrees to about 5.0 degrees, from about 2.0 degrees to about 5.0 degrees, from about 2.5 degrees to about 5.0 degrees, from about 3.0 degrees to about 5.0 degrees, from about 3.5 degrees to about 5.0 degrees, from about 4.0 degrees to about 5.0 degrees, from about 4.5 degrees to about 5.0 degrees, or any individual value therein.

In some embodiments, wire body 104 and/or handle receiver 106 is substantially circular, substantially square, or substantially tapered.

In some embodiments, wire body 104 in the expanded configuration has a length in a range from about 5 inches to about 9 inches. In some embodiments, the wire body in the expanded configuration has a length of about 7.0 inches. In some embodiments, the wire body in the expanded configuration has a length in a range from about 5 inches to about 8 inches, from about 5 inches to about 7 inches, from about 5 inches to about 6 inches, from about 6 inches to about 9 inches, from about 7 inches to about 9 inches, from about 8 inches to about 9 inches, or any individual value therein.

In some embodiments, wire body 104 in the expanded configuration has a pitch in a range from about 0.4 inches to about 0.8 inches. In some embodiments, the wire body in the expanded configuration has a pitch of about 0.6 inches. In some embodiments, the wire body in the expanded configuration has a pitch in a range from about 0.4 inches to about 0.7 inches, from about 0.4 inches to about 0.6 inches, from about 0.4 inches to about 0.5 inches, from about 0.5 inches to about 0.8 inches, from about 0.6 inches to about 0.8 inches, from about 0.7 inches to about 0.8 inches, or any individual value therein.

In some embodiments, wire body 104 has a diameter in a range from about 2.0 inches to about 5.0 inches. In some embodiments, the wire body has a diameter of about 3.5 inches. In some embodiments, the wire body has a diameter in a range from about 2.0 inches to about 4.5 inches, from about 2.0 inches to about 4.0 inches, from about 2.0 inches to about 3.5 inches, from about 2.0 inches to about 3.0 inches, from about 2.0 inches to about 2.5 inches, from about 2.5 inches to about 5.0 inches, from about 3.0 inches to about 5.0 inches, from about 3.5 inches to about 5.0 inches, from about 4.0 inches to about 5.0 inches, from about 4.5 inches to about 5.0 inches, or any individual value therein.

In some embodiments, wire body 104 in the collapsed configuration has a length in a range from about 0.1 inches to about 4.0 inches. In some embodiments, the wire body in the collapsed configuration has a length of about 2.0 inches. In some embodiments, the wire body in the collapsed configuration has a length in a range from about 0.1 inches to about 3.5 inches, from about 0.1 inches to about 3.0 inches, from about 0.1 inches to about 2.5 inches, from about 0.1 inches to about 2.0 inches, from about 0.1 inches to about 1.5 inches, from about 0.1 inches to about 1.0 inch, from about 0.1 inches to about 0.5 inches, from about 0.5 inches to about 4.0 inches, from about 1.0 inch to about 4.0 inches, from about 1.5 inches to about 4.0 inches, from about 2.0 inches to about 4.0 inches, from about 2.5 inches to about 4.0 inches, from about 3.0 inches to about 4.0 inches, from about 3.5 inches to about 4.0 inches, or any individual value therein.

In some embodiments, handle receiver 106 has a length in a range from about 0.5 inches to about 3.0 inches. In some embodiments, the handle receiver has a length of about 1.75 inches. In some embodiments, the handle receiver has a length in a range from about 0.5 inches to about 2.5 inches, from about 0.5 inches to about 2.0 inches, from about 0.5 inches to about 1.5 inches, from about 0.5 inches to about 1.0 inch, from about 1.0 inch to about 3.0 inches, from about 1.5 inches to about 3.0 inches, from about 2.0 inches to about 3.0 inches, from about 2.5 inches to about 3.0 inches, or any individual value therein.

In some embodiments, handle receiver 106 has a pitch in a range from about 0.05 inches to about 0.4 inches. In some embodiments, the handle receiver has a pitch of about 0.25 inches. In some embodiments, the handle receiver has a pitch in a range from about 0.05 inches to about 0.35 inches, from about 0.05 inches to about 0.3 inches, from about 0.05 inches to about 0.25 inches, from about 0.05 inches to about 0.2 inches, from about 0.05 inches to about 0.15 inches, from about 0.05 inches to about 0.1 inches, from about 0.1 inches to about 0.4 inches, from about 0.15 inches to about 0.4 inches, from about 0.2 inches to about 0.4 inches, from about 0.25 inches to about 0.4 inches, from about 0.3 inches to about 0.4 inches, from about 0.35 inches to about 0.4 inches, or any individual value therein.

In some embodiments, handle receiver 106 has a diameter in a range from about 0.5 inches to about 1.5 inches. In some embodiments, the handle receiver has a diameter of about 1.0 inch. In some embodiments, the handle receiver has a diameter in a range from about 0.5 inches to about 1.25 inches, from about 0.5 inches to about 1.0 inch, from about 0.5 inches to about 0.75 inches, from about 0.75 inches to about 1.5 inches, from about 1.0 inch to about 1.5 inches, from about 1.25 inches to about 1.5 inches, or any individual value therein.

In some embodiment, wire body 104 may comprise an outer surface and an inner surface. In some embodiments, the outer surface of wire body 104 may comprise an identification plate. In some embodiments, a length from a center of handle receiver 106 to the outer surface of wire body 104 is in a range from about 0.5 inches to about 1.5 inches. In some embodiments, the length from the center of the handle receiver to the outer surface of the wire body is about 1.0 inch. In some embodiments, the length from the center of the handle receiver to the outer surface of the wire body is in a range from about 0.5 inches to about 1.25 inches, from about 0.5 inches to about 1.0 inch, from about 0.5 inches to about 0.75 inches, from about 0.75 inches to about 1.5 inches, from about 1.0 inch to about 1.5 inches, from about 1.25 inches to about 1.5 inches, of any individual value therein.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

“About” as used herein means ±10% of the referenced value. In certain embodiments, “about” means ±9%, or ±8%, or ±7%, or ±6%, or ±5%, or ±4%, or ±3%, or ±2% or ±1% of the referenced value.

1. A collapsible roasting basket, comprising:
a wire body having a top portion, a bottom portion, an expanded configuration, and a collapsed configuration; and
a handle receiver located in the top portion, the handle receiver having a first end and a second end, the first end engaging a portion of the top portion of the wire body.

2. The collapsible roasting basket of claim 1, wherein the second end of the handle receiver comprises an integral hook.

3. The collapsible roasting basket of claim 2, further comprising a hook receiver located in the bottom portion of the wire body.

4. The collapsible roasting basket of claim 3, wherein in the collapsed configuration, the integral hook of the handle receiver engages the hook receiver.

5. The collapsible roasting basket of claim 3, wherein the wire body, the handle receiver, and the hook receiver comprise one or more material, wherein the one or more material is a heat resistant material or a resilient material.

6. The collapsible roasting basket of claim 1, wherein the handle receiver is coiled.

7. The collapsible roasting basket of claim 1, further comprising a rod configured to engage the handle receiver.

8. The collapsible roasting basket of claim 7, wherein the rod is a telescoping rod.

9. The collapsible roasting basket of claim 1, wherein at least a portion of the handle receiver is located within the wire body of the collapsible roasting basket.

10. The collapsible roasting basket of claim 1, wherein at least a portion of the handle receiver is located outside the wire body of the collapsible roasting basket.

11. The collapsible roasting basket of claim 1, wherein the wire body is coiled.

12. The collapsible roasting basket of claim 1, wherein the wire body is substantially circular, substantially square, or substantially tapered.

13. The collapsible roasting basket of claim 1, wherein the handle receiver is substantially circular, substantially square, or substantially tapered.

14. The collapsible roasting basket of claim 1, wherein the bottom portion of the wire body comprises a bottom plate.

15. The collapsible roasting basket of claim 1, wherein the wire body in the expanded configuration has a pitch in a range from about 0.4 inches to about 0.8 inches.

16. The collapsible roasting basket of claim 15, wherein the pitch is about 0.6 inches.

17. The collapsible roasting basket of claim 1, wherein the wire body in the collapsed configuration has a length in a range from about 0.1 inches to about 4.0 inches.

18. The collapsible roasting basket of claim 17, wherein the length is about 2.0 inches.

19. The collapsible roasting basket of claim 1, wherein the wire body has a taper up to 5.0 degrees.

20. The collapsible roasting basket of claim 1, wherein the handle receiver has a taper up to 5.0 degrees.
